(19) United States
(12) Patent Application Publication
(10) Pub. No.: US 2020/0369091 A1
(43) Pub. Date: Nov. 26, 2020

(54) TIRE TREAD HAVING TREAD BLOCKS WITH INCLINED TRAILING SIDE AND SIPE

(71) Applicant: COMPAGNIE GENERALE DES ETABLISSMENTS MICHELIN, Clermont-Ferrand (FR)

(72) Inventors: Chad M. D'ESPOSITO, Simpsonville, SC (US); Robert C. LAWSON, Pelzer, SC (US)

(73) Assignee: COMPAGNIE GENERALE DES ETABLISSMENTS MICHELIN, Clermont-Ferrand (FR)

(21) Appl. No.: 16/635,487

(22) PCT Filed: Jul. 31, 2017
(86) PCT No.: PCT/US2017/044685

§ 371 Date: Jan. 30, 2020

(51) Int. Cl. B60C 11/11; B60C 11/12

(52) U.S. Cl. CPC B60C 11/11; B60C 11/0306; B60C 11/1281

(57) ABSTRACT

Embodiments of the disclosure include a tire tread having tread blocks (24) each defined by a pair of lateral grooves (20) each being asymmetric whereby a first portion (26) of a trailing side (TS24) the tread block is inclined and extends to a peak (28), and whereby a recess (38) projects into tread block below the first portion. Each tread block also includes a sipe (22) extending into the tread thickness from the outer, ground-engaging side of the tread, where the sipe is generally inclined relative to the direction of the tread thickness, such that as the sipe extends into the tread thickness from the outer, ground-engaging side, the sipe extends towards the trailing side (TS24) of the corresponding tread block, the sipe including a groove (40) arranged along the sipe within the tread thickness and spaced below the outer, ground-engaging side of the tread. The groove being asymmetric relative to a centerline (CL22) of the sipe.

### BACKGROUND

### Field

Embodiments relates generally to tire treads for tires.

### Description of the Related Art

Tires, whether pneumatic or non-pneumatic, include a tread configured to develop traction (adherence) between the vehicle and a road surface, whether during braking, acceleration, or cornering. When a tire undergoes dry braking, there is a peak pressure at the trailing edge of each tread block within a contact patch (that is, the tire footprint), which is where the tire engages a road surface. This trailing edge, when the associated tread block is under braking, is also referred to as a braking leading edge. Generally, the higher the pressure, the lower the coefficient of friction. Traditionally, this peak pressure is lowered by decreasing the void content within the tire tread. Unfortunately, the removal of void has a negative impact on wet and snow traction. Therefore, there is a need to reduce the peak pressure for dry braking without removing void content from the tread and sacrificing wet and snow performance.

### SUMMARY

Embodiments of this disclosure include a tire tread, the tire tread comprising a thickness extending from an outer, ground-engaging side and to a bottom side, the thickness extending in a direction perpendicular to both a length and a width of the tread, the width extending between a pair of lateral sides of the tread, where the tread length is greater than the tread width. The tread also includes a plurality of tread blocks arranged along the outer, ground-engaging side, each tread block having a leading side and a trailing side, where the leading side precedes the trailing side in a direction of forward tread rotation, each leading and trailing side extending into the tread thickness from the outer, ground-engaging side and generally in a direction of the tread length, each leading and trailing side being defined by one of a plurality of lateral grooves extending generally in the direction of the tread width. Each of the plurality of tread blocks also includes a pair of lateral sides extending into the tread thickness from the ground-engaging side and generally in a direction of the tread width, each lateral side of the pair of lateral sides being defined by one of a pair of longitudinal grooves extending generally in the direction of the tread length. Each of the plurality of lateral grooves is asymmetric relative to the direction of the tread thickness, whereby a first portion of the trailing side for each corresponding tread block extends into the tread thickness from the outer, ground-engaging side while also extending toward a centerline of the corresponding adjacent lateral groove and to a peak and whereby a recess projects into tread block at a location within the tread thickness below the first portion. Each of the plurality of tread blocks includes a sipe extending into the tread thickness from the outer, ground-engaging side of the tread, where the sipe is generally inclined relative to the direction of the tread thickness, such that as the sipe extends into the tread thickness from the outer, ground-engaging side, the sipe extends towards the trailing side of the corresponding tread block. A groove is arranged along the sipe within the tread thickness and spaced below the outer, ground-engaging side of the tread. the groove being asymmetric relative to a centerline of the sipe, the centerline arranged midway across a width of the sipe as the sipe extends into the tread thickness from the outer, ground-engaging side.

The foregoing and other objects, features, and advantages will be apparent from the following more detailed descriptions of particular embodiments, as illustrated in the accompanying drawings wherein like reference numbers represent like parts of particular embodiments.

### DETAILED DESCRIPTION OF THE DRAWINGS

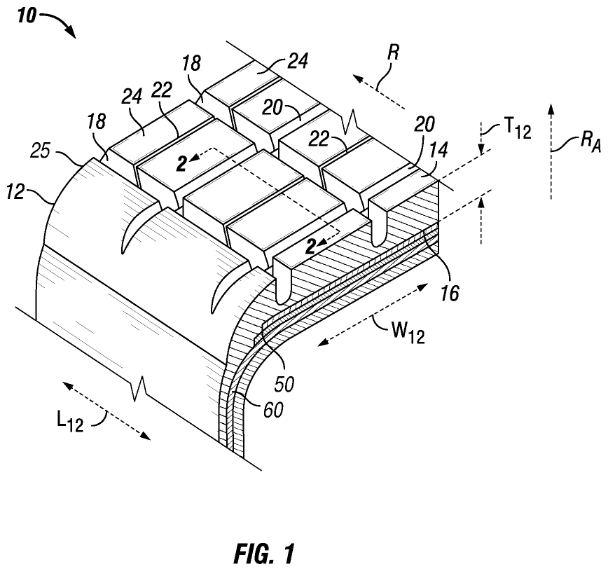

FIG. 1 is a top perspective view of a portion of a tire, showing a tire tread arranged along a tire carcass, in accordance with an exemplary embodiment;

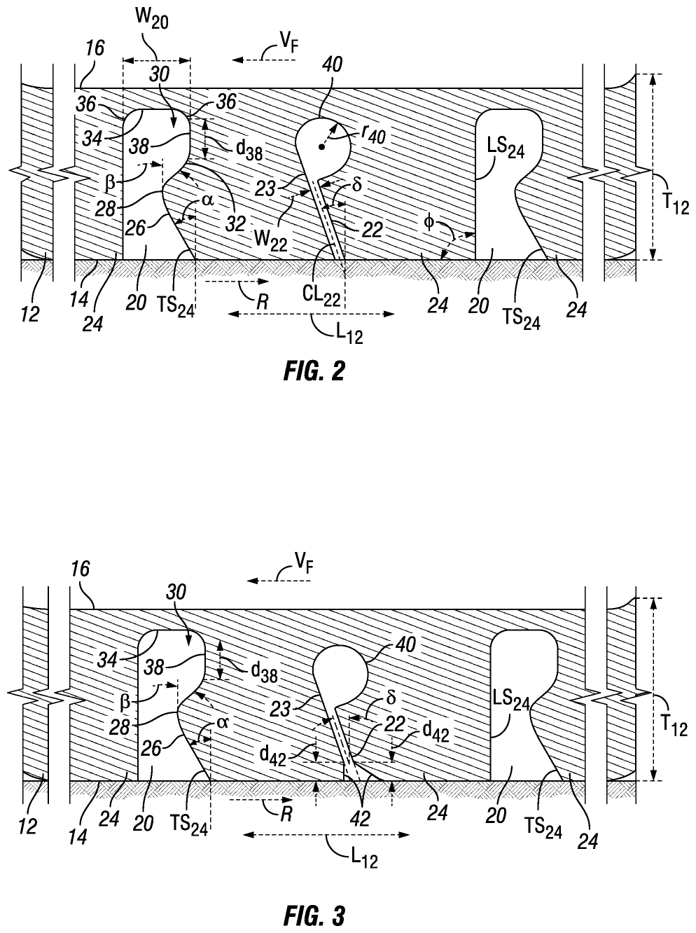

FIG. 2 is a side sectional view of the tire tread shown in FIG. 1 taken along line 2-2;

FIG. 3 is a variation of the tire tread shown in FIG. 2, in accordance with another exemplary embodiment;

### DETAILED DESCRIPTION OF PARTICULAR EMBODIMENTS

This disclosure provides improved dry traction by reducing the braking leading edge pressure while improving wet and snow performance over traditional methods for improving braking leading edge pressure. In particular, the treads described in this disclosure achieve improved dry braking by virtue of providing asymmetric lateral grooves (asymmetric in the longitudinal direction of the tread) and lateral sipes that include submerged grooves, where the groove is asymmetric relative to a widthwise centerline of the sipe, where each assist in reducing braking leading edge pressure without sacrificing tread void. This also improves snow traction by improving the pressure distribution within the contact patch. Tread wear and dry braking is also improved by inclining the tread blocks in the forward rolling direction to reduce braking leading edge pressure without negatively impacting other tire performance measures. Hidden voids, by virture of the asymmetric lateral grooves and the submerged groove arranged along the sipe, improves end of life wet performance.

The present disclosure concerns tire treads, with void features that may be formed by any desired means, such as by molding or by hot knife. The tire treads may be formed with a tire, such as when forming an original tire, or separately, such as when forming treads for retreading operations.

A tire tread according to the present disclosure includes a length, width, and a thickness. The thickness extends from an outer, ground-engaging side of the tread and to a bottom side of the tread. The thickness can be said to extend in a direction perpendicular to both the length and the width of the tread. In other words, the direction of the tread thickness is a direction perpendicular to both the direction of the tread width and the direction of the tread length. The direction of the tread thickness is also perpendicular to the outer, ground-engaging side. When the tire tread is arranged on a tire for use, the direction of the tread thickness extends in a radial direction at a widthwise centerline of the tire tread. The widthwise centerline of the tread coincides with an equatorial centerplane of the tire tread. The tread width extends between a pair of lateral sides of the tread. It can be said that the tread length is greater than the tread width.

Due to the presence of void features described herein, the tread includes a plurality of tread blocks arranged along the outer, ground-engaging side. The void features comprise intersecting longitudinal and lateral grooves. Each tread block is described as having a leading side and a trailing side, each leading and trailing side extending into the tread thickness from the outer, ground-engaging side and extending generally in a direction of the tread length. In distinguishing between the leading and trailing sides, the leading side precedes the trailing side in a direction of forward tread rotation, such that the leading side approaches a surface upon which a tire is operating (a tire operating surface) before the trailing side for any such tread block. Under braking, the trailing side under forward rotation becomes the braking leading side, that is, the leading side under braking, since the trailing side is the leading side as the tire slides relative the road surface under braking. It follows that the leading side under forward rotation becomes the trailing side under braking, that is, the braking trailing side. Herein, the leading side under braking is identified as the braking leading side, and the trailing side under braking is identified as the braking trailing side. Otherwise, unless a leading or trailing side is associated with braking, reference to a leading or trailing side is associated with forward rotation.

It is noted that each leading and trailing side is defined by (that is, formed by) one of a plurality of lateral grooves extending generally in the direction of the tread width. Accordingly, each one of the lateral grooves can be described as being arranged adjacent to a leading and/or trailing side of each tread block. “Generally in the direction of the tread width” indicates that the lateral groove extends primarily in the direction of the tread width, such that in separating the direction into a pair of vectors, one extending in the direction of the tread width (forming a lateral vector) and the other extending in the direction of the tread length (a longitudinal vector), the lateral vector being greater than any longitudinal vector. It is appreciated that the longitudinal vector may be zero, such that a general direction of the tread width is the direction of the tread width. In certain exemplary instances, the lateral grooves have a height of 6 millimeters (mm) to 12 mm, although other heights may be employed.

It is further noted that each tread block has a pair of spaced apart lateral sides, that is, sides spaced is in a general direction of the tread width. The pair of lateral sides define a width of the tread block, while the leading and trailing sides define a length of the corresponding tread block. Each lateral side extends into the tread thickness from the outer, ground-engaging side and is defined by (that is, formed by) either a longitudinal groove or a shoulder of the tread. A shoulder of the tread is a free, exterior side edge arranged at or near a lateral side of the tread. The shoulder defines the widthwise extent of the outer, ground-engaging side of the tread, whereby the width of the outer, ground-engaging surface is defined by a pair of spaced apart shoulders. A longitudinal groove and a shoulder each extend generally in the direction of the tread length. “Generally in the direction of the tread length” indicates that any longitudinal groove or shoulder extends primarily in the direction of the tread length, such that in separating the direction into a pair of vectors, one extending in the direction of the tread length (longitudinal vector) and the other extending in the direction of the tread width (lateral vector), the longitudinal vector is greater than the lateral vector. It is appreciated that the lateral vector may be zero, such that a general direction of the tread length is the direction of the tread length.

Each lateral groove of the plurality of lateral grooves is asymmetric across its width, that is, when viewing the groove in a widthwise cross-section relative to a centerline extending in the direction of the tread thickness located halfway across the lateral groove width. The centerline may also represent a plane extending along the length of the lateral groove, where symmetry is evaluated relative to this plane. In being asymmetric, a first portion of the trailing side for a corresponding tread block extends into the tread thickness from the outer, ground-engaging side while also extending toward a centerline of the corresponding adjacent lateral groove. The first portion extends ultimately to a peak arranged along the trailing side. Accordingly, the first portion is inclined relative to the direction of the tread thickness. It is appreciated that the peak forms a projection extending into the width of the lateral groove, by virtue of the first portion being inclined, and in certain instances the peak forms a location of minimum width of the lateral groove. In certain variations, the peak forms a single point of maximum projection, while in other variations the peak extends a distance greater than a single point to define a distance of maximum projection.

It is appreciated that the first portion may extend linearly and/or non-linearly in cross-section. Accordingly, the first inclined portion of the trailing side extends into the tread thickness by an average non-zero angle measured relative to the direction of the tread thickness, where the non-zero angle may be any positive angle, such as any angle from 6 degrees to 60 degrees and in more specific instances, from 40 to 50 degrees or substantially 45 degrees. In certain instances, the first inclined portion includes a planar portion, the planar portion being inclined by any average non-zero angle contemplated above. When any portion of the first portion extends non-linearly, an average angle for the first portion may be determined using linear regression to determine a linear equivalent for the full extent of the first portion. This is just one of many known techniques that may be employed for determining an average angle for any non-linear extension for any feature discussed herein.

In being asymmetric, each corresponding lateral groove also includes a recess projecting into a corresponding tread block along the trailing side at a location within the tread thickness below the first portion. Therefore, the recess can be described as being submerged below the outer, ground-engaging side, such as to form a submerged groove. The peak described above is arranged between the first portion and the recess. It is appreciated that a single peak may be arranged between the first portion and the recess or, in other variations, multiple peaks (that is, multiple projections) may be arranged between the first portion and the recess.

In certain instances, the trailing side includes a second portion extending from the peak further into the tread thickness. The second portion is inclined relative to the direction of the tread thickness by extending at least partially in the direction of the tread block length (that is, in a direction of the tread length or in a direction towards the leading side of the tread block). Accordingly, the second portion may extend entirely in a direction of the tread block length or in both the direction of the tread block length and the direction of the tread thickness. In certain variations, the second portion at least partially defines the recess. The second portion may also be described as extending into the tread thickness by an average non-zero angle measured relative to the direction of the tread thickness, which contemplates that the second portion may extend linearly and/or non-linearly in cross-section. By way of example, the average non-zero is equal to 6 degrees to 60 degrees and in more specific instances, from 40 to 50 degrees or substantially 45 degrees. In certain instances, at least a portion extends linearly to form a planar portion. In such instances, the planar portion may be defined by the average non-zero angle described previously or the entire second portion, which would include any other linear or non-linear portions of the second portion. The second portion may be spaced apart from the bottom of a corresponding lateral groove. In such instances, the trailing side further includes a third portion extending generally in the direction of the tread thickness from the second portion and to the bottom. This third portion may extend linearly and/or non-linearly in cross-section, and in certain instances, includes a planar portion. In certain exemplary instances, the planar portion extends a height between the second portion and the bottom by a distance of 0.5 mm to 1/3 of the lateral groove height or in more particular instances by a distance of substantially 1.25 mm. By virtue of including the second portion and the third portion, the recess can be described as forming a quadrilateral cross-sectional shape. It is appreciated that the recess may form any desired shape in other instances. For example, in lieu of having second and third portions, a single portion may extend from a bottom of the corresponding lateral groove and up to the peak to form a partial circle or oval. It is also appreciated that the recess may be arranged to extend to a bottom of a corresponding lateral groove or may be arranged spaced apart from the bottom.

As already suggested, each lateral groove of the plurality of lateral grooves includes a bottom, the bottom forming a terminal extent of the corresponding lateral groove within the tread thickness. It follows that the bottom defines a depth (that is, a height) of each corresponding lateral groove, the depth extending from the outer, ground-engaging side and to the bottom. While the bottom may take any desired form, in certain instances the bottom includes a planar portion extending substantially across a width of the corresponding lateral groove, even though the bottom may still include periodic wear bars, stone ejectors, or other projecting features periodically spaced-apart along the length of the lateral groove. Whether or not the bottom includes the planar portion, in particular instances each of the plurality of lateral grooves includes a tapering transition is arranged at a junction between the bottom and each of the leading and trailing sides to reduce stress concentrations that may occur at the junctions between the leading and trailing sides and the bottom and result in crack formation or tears. In particular instances, each transition forms a fillet or chamfer When forming a fillet, in certain exemplary instances, the radius of the fillet may be 0.5 mm to 1.5 mm, or in more particular instances substantially 0.75 mm.

Each tread block of the plurality of tread blocks also includes a sipe extending into the tread thickness from the outer, ground-engaging side of the tread. Each such sipe extends into the tread thickness linearly, or non-linearly, and is generally inclined relative to the direction of the tread thickness, such that as the sipe extends into the tread thickness from the outer, ground-engaging side, the sipe extends towards the trailing side of the corresponding tread block. In certain instances, the sipe has a thickness that remains substantially constant along its length, while in other instances, the sipe thickness may be variable. It is appreciated that the sipe thickness may equal any thickness from zero (a cut slit) up to 1.2 millimeters (mm). To the contrary, one of ordinary skill would recognize the difference between a sipe and a groove, where for any longitudinal or lateral groove, the groove has a thickness greater than 1.2 mm. In particular, a sipe has thickness (also referred to as a width herein) that is designed to open and close, that is contact, during tire operation, where a groove thickness (width) remains open. In measuring the inclination of the sipe, for a constant thickness sipe, the inclination may be measured from any side wall of the sipe or from a centerline of the sipe. For a variable thickness sipe, the inclination angle is measured from a centerline of the thickness, the centerline extending the length of the sipe midway across the sipe thickness. It can be said that the sipe centerline forms a path along which the sipe extends within the tread thickness. Accordingly, the sipe is inclined by an average angle measured relative to the direction of the tread thickness. In particular instances, the average angle of the inclined sipe is a non-zero angle, such as any angle equal to 0 to 45 degrees, for example. In other instances, the average angle is equal to one-half of the average angle of the first portion of the trailing side. If the sipe extends into the tread thickness non-linearly, the sipe inclination is measured relative to a linear average of the path extending along the centerline of the sipe, the linear average being determined using linear regression or any other similar technique.

In certain variations of any embodiment contemplated herein, the sipe includes a groove arranged along the sipe within the tread thickness and spaced below the outer, ground-engaging side of the tread. Accordingly, this groove can be referred to as a submerged groove. The groove is asymmetric relative to a centerline of the sipe, the centerline arranged midway across a width of the sipe as the sipe extends into the tread thickness from the outer, ground-engaging side. In particular instances, the groove is arranged at an inner terminal end of the sipe within the tread thickness, although in other instances, the groove may be arranged above the inner terminal end of the sipe. The groove extends outwardly from the sipe in a direction towards the leading side, that is, the groove extends outwardly from the leading side of the sipe. In certain variations, a portion of the groove may extend outwardly from the trailing side of the sipe, but this is insubstantial as the groove primarily extends from leading side of the sipe. It is appreciated that the groove may form any desired cross-sectional shape, such as a partial circle, oval, or quadrilateral, or the like. In certain exemplary instances, the groove is a partial circle in cross-section, having a radius of 0.3 mm to 3 mm or in more particular instances a radius equal to 0.5 mm to 1.5 mm The groove may also extend a partial or full length of the sipe.

Additionally, or in the alternative, one or more tapering segments may be arranged at a junction between the sipe and the outer, ground-engaging side. Each tapering segment forms a transition between the sipe and the outer, ground-engaging side of the tread. In certain instances, this tapering segment extends outwardly in the direction of the tread length from the sipe as the tapering segment extends towards the outer, ground-engaging side. The tapering segment may extend linearly or non-linearly. For example, the tapering segment may form a chamfer or fillet. It is appreciated that the tapering segment may be arranged on the leading side of the sipe and/or on the trailing side of sipe. In certain instances, any tapering segment extends 0.5 to 2 mm into the tread thickness form the outer, ground-engaging side, or in more particular instances, by substantially 1 mm.

As generally discussed previously, each leading and trailing side extends into the tread thickness from the outer, ground-engaging side. As noted previously, the first portion is inclined relative to the direction of the tread thickness. As noted previously, the direction of the tread thickness is a direction perpendicular to the outer, ground-engaging side. With regard to the leading side, in particular instances the leading side extends into the tread thickness from the outer, ground-engaging side in the direction of the tread thickness. This may be for the entire depth (i.e., height) of the leading side, or at least for a partial depth of the leading side. For example, a portion of the leading side depth extending from the outer, ground engaging side of the tread extends in the direction of the tread thickness. In other instances, the trailing side may be inclined to extend partially in the direction of the tread thickness. In certain instances, at least the portion of the leading side extending from the outer, ground-engaging side extends into the tread thickness at an angle of 84 to 96 degrees relative to the direction of the tread thickness, or, in more specific embodiments, at an angle of 90 degrees, where this portion extends linearly in cross-section, or is planar in three dimensions. This portion may extend partially for substantially the full depth of the leading side height.

Certain exemplary embodiments will now be discussed below in association with the figures.

With reference to FIG. 1, a sectional perspective view of a tire 10 is shown in accordance with a particular embodiment. Tire 10 includes a tread 12 arranged overtop one or more belt plies 50 and one or more body (carcass) plies 60. Tread 12 includes various void features, including longitudinal grooves 18, lateral grooves 20, and sipes 22 arranged in fluid communication with an outer, ground-engaging side 14 of tread 12 as each extend into the tread thickness T₁₂ from the outer, ground-engaging side 14. The tread also includes a plurality of tread blocks 24 at least partially defined by longitudinal grooves 18 and lateral grooves 20. Shoulders 25, which define the width of the outer, ground-engaging side 14, also assist in at least partially defining certain tread blocks 24. Tire tread 12 has a thickness T₁₂ bounded by the outer, ground-engaging side 14 and a bottom side 16. Tread thickness T₁₂ may remain constant or vary across the tread. Tread thickness T₁₂ extends in a direction perpendicular to the outer, ground-engaging side 14 or to the bottom side 16. The radial direction of the tire is identified as R_{A}, while the direction of forward tire rotation is identified as R. Also, the tread width is identified as W₁₂, while the tread length is identified as L₁₂.

With reference to FIG. 2, a lengthwise cross-section of a tread block 24 is shown in accordance with an exemplary embodiment. In particular, a tread block length (which extends in the direction of the tread length L₁₂) is defined by opposing lateral grooves 20 that are spaced apart in a direction of the tread length L₁₂. A sipe 22 is arranged within the length of the tread block between the leading and trailing sides LS₂₄, TS₂₄. The direction of intended forward rotation is identified as R, while the direction of forward vehicle travel is identified as Y_{F}. It follows that each tread block 24 has a leading side LS₂₄ and a trailing side TS₂₄, each defined by (and formed by) one of the lateral grooves 20. Each leading and trailing side LS₂₄, TS₂₄ extends into the tread thickness T₁₂ from the outer, ground-engaging side 14 and generally in a direction of the tread length. In distinguishing between the leading and trailing sides LS₂₄, TS₂₄, the leading side LS₂₄ precedes the trailing side TS₂₄ in a direction of forward tread rotation R, such that the leading side LS₂₄ approaches a surface upon which a tire is operating (a tire operating surface) before the trailing side TS₂₄ for any such tread block 24. While this embodiment shows adjacent tread blocks being of the same design, it is appreciated that in other embodiments, adjacent tread blocks may be of different designs.

With continued reference to FIG. 2, each lateral groove 20 is asymmetric relative to a centerline CL₂₀ extending in the direction of the tread thickness halfway across the lateral groove width W₂₀, or relative to a plane extending both in the direction of the tread thickness and in a direction of the lateral groove length (which is generally in the direction of the tread width) halfway across the lateral groove width W₂₀. Accordingly, centerline CL₂₀ is arranged within the plane, such that the plane extends through the centerline CL₂₀. In being asymmetric, a first portion 26 of the trailing side TS₂₄ for each corresponding tread block 24 extends into the tread thickness T₁₂ from the outer, ground-engaging side 14 while also extending toward centerline CL₂₀ of the corresponding adjacent lateral groove 20. First portion 26 terminates at a peak 28 arranged along the trailing side TS₂₄. Accordingly, the first portion 26 is inclined relative to the direction of the tread thickness by an angle α. While other variations may be employed, in certain instances, angle α is equal to any angle from 6 degrees to 60 degrees. In the embodiment shown, first portion extends linearly in cross-section to provide a planar portion. However, it is also contemplated that first portion may extend non-linearly in cross-section, where angle α would then represent an average inclination angle of first portion, which may be measured, for example, by generating a line representing a linear regression of a non-linear first portion. Peak 28 forms a projection extending into the width W₂₀ of lateral groove 20. In this embodiment, peak 28 also forms a location of minimum width W₂₀ of lateral groove 20. It is appreciated that peak 28 forms a single point of maximum projection into the groove width W₂₀.

With continued reference to FIG. 2, a recess 30 is shown projecting into tread block 24 at a location below first portion 26 within tread thickness T₁₂, such that recess 30 is spaced apart from outer, ground-engaging side 14. It follows that peak 28 is arranged between first portion 26 and recess 30. In this embodiment, recess 30 extends into tread block 24 from peak 28, and more specifically, by way of second portion 32. Accordingly, second portion 32 partially defines recess 30. Second portion 32 shown to be inclined, extending from peak 28 further into the tread thickness in both in the direction of the tread thickness and in a direction towards the leading side of the corresponding tread block 24. In this embodiment, second portion includes a planar portion extending linearly in cross-section and is inclined by angle relative to the direction of the tread thickness. While angle β may comprise any non-zero angle as desired, in particular instances angle β equals any angle from 6 to 60 degrees. In this instance, second portion 32 is spaced apart from a bottom 34 of the corresponding lateral groove 20, whereby a third portion 38 of the trailing side extends from or between the second portion to the bottom side. In the embodiment shown, the third portion includes a planar portion extending linearly in cross-section. In this instance, the third portion extends substantially in the direction of the tread thickness, but may extend at an inclination angle (positive or negative non-zero angle) relative to the direction of the tread thickness. By virtue of including the second portion 32 and the third portion 38, the recess 30 can be described as forming a quadrilateral cross-sectional shape.

With continued reference to FIG. 2, it is shown that each lateral groove 20 of the plurality of lateral grooves includes a bottom 34, the bottom forming a terminal extent of the corresponding lateral groove 20 within the tread thickness T₁₂. It follows that bottom 34 defines a depth (i.e., height) of a corresponding lateral groove 20, the depth extending in the direction of the tread thickness from the outer, ground-engaging side 14 and to the bottom 34. In the variation shown, bottom 34 includes a planar portion extending substantially across width W₂₀ of the corresponding lateral groove 20. Further, each lateral groove 20 of the plurality of lateral grooves includes a tapering transition 36 arranged at a junction between bottom 34 and each of the leading and trailing sides LS₂₄, TS₂₄. In the variation shown, each transition 36 forms a fillet. As stated previously, these tapering portions can reduce the stress concentrations at the junctions between the leading and trailing sides and the bottom, so to reduce crack formation or tears.

As noted previously, the tread block 24 shown in FIG. 2 also includes sipe 22 extending into the tread thickness from the outer, ground-engaging side 14 of tread 12. Sipe 22 is generally inclined relative to the direction of the tread thickness T₁₂, such that as sipe 22 extends into the tread thickness T₁₂ from outer, ground-engaging side 14, sipe 22 extends towards the trailing side TS₂₄ of tread block 24. Sipe 22 has a width W₂₂ (also referred to as a thickness) that remains substantially constant along its height. It is appreciated that the sipe width may equal any thickness from zero (a cut slit) up to 1.2 millimeters (mm). To the contrary, one of ordinary skill would recognize the difference between sipe 22 and a groove, namely, any longitudinal groove 18 (see FIG. 1) or lateral groove 20, as the groove has a thickness greater than 1.2 mm. In measuring the inclination of the sipe, because sipe 22 extends linearly and has a constant thickness along its height, the inclination may be measured from any side wall of the sipe defining the sipe width W₂₂ or from a centerline CL₂₂ of the sipe 22. In particular instances, the inclination angle δ of sipe 22 is a non-zero angle, such as any angle equal to 0 to 45 degrees, for example. By further example, inclination angle δ is equal to one-half of inclination angle α of first portion 26 of the trailing side TS₂₄.

The variation shown in FIG. 2 also depicts a leading side LS₂₄ extending linearly in the direction of the tread thickness T₁₂ from the outer, ground-engaging side 14. Accordingly, the outer, ground-engaging side 14 and the leading side LS₂₄ are relationally separated by an angle φ equal to 90 degrees. In this variation, the leading side LS₂₄ extends perpendicular to the outer, ground-engaging side 14 for substantially the entire depth (i.e., height) of the leading side, or, that is, in the direction of the tread thickness. In other variations, angle φ equal is to 84 to 96 degrees.

With continued reference to FIG. 2, sipe 22 includes a groove 40 arranged along its height but spaced below the outer, ground-engaging side 14. In this instance, the groove 40 is arranged at an inner terminal end 23 of the sipe. Groove 40 extends from sipe 22 in a direction towards the leading side LS₂₄ of the corresponding tread block 24. Stated differently, groove 40 is arranged on the leading side LS₂₄ of sipe 22. In the exemplary embodiment shown, the groove has a generally circular in cross-sectional shape, meaning, it forms a partial circle having radius r₄₀. While radius r₄₀ may be any desired radius, in particular instances, radius r₄₀ is equal to 0.3 mm to 3.0 mm. It is appreciated that the groove may be added to any sipe according to any variation contemplated herein and in any tread embodiment contemplated herein which may comprise any combination of features described herein.

With reference now to FIG. 3, a variation of the embodiment in FIG. 2 is shown. In this embodiment, tapering segments 42 are arranged at a junction between sipe 22 and the outer, ground-engaging side 14. Dashed lines depict where the outer, ground-engaging side 14 and the sipe 22 would have intersected without the presence of tapering segments 42. Each tapering segment 42 forms a transition between the sipe 22 and the outer, ground-engaging side 14. Each tapering segment 42 extends outwardly in the direction of the tread length L from the sipe 22 as the tapering segment 42 extends towards the outer, ground-engaging side 14. In this instance, tapering segment 42 extends linearly to form a chamfer. It is appreciated that tapering segment 42 extends a distance d₄₂ into the tread thickness T₁₂ from the outer, ground-engaging side 14. For example, distance d₄₂ may equal 0.5 mm to 2 mm, and in more specific instances substantially 1 mm. It is appreciated that any one or more tapering segments 42 may be added to any sipe according to any variation contemplated herein and in any tread embodiment contemplated herein which may comprise any combination of features described herein. This includes only arranging a tapering segment 42 on only one of the leading and trailing sides LS₄₂, TS₄₂.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

1. A tire tread comprising:
a thickness extending from an outer, ground-engaging side and to a bottom side, the thickness extending in a direction perpendicular to both a length and a width of the tread, the width extending between a pair of lateral sides of the tread, where the tread length is greater than the tread width;
a plurality of tread blocks arranged along the outer, ground-engaging side, each tread block having a leading side and a trailing side, where the leading side precedes the trailing side in a direction of forward tread rotation, each leading and trailing side extending into the tread thickness from the outer, ground-engaging side and generally in a direction of the tread length, each leading and trailing side being defined by one of a plurality of lateral grooves extending generally in the direction of the tread width;
each of the plurality of tread blocks also includes a pair of lateral sides extending into the tread thickness from the ground-engaging side and generally in a direction of the tread width, each lateral side of the pair of lateral sides being defined by one of a pair of longitudinal grooves extending generally in the direction of the tread length;
where each of the plurality of lateral grooves is asymmetric relative to the direction of the tread thickness, whereby a first portion of the trailing side for each corresponding tread block extends into the tread thickness from the outer, ground-engaging side while also extending toward a centerline of the corresponding adjacent lateral groove and to a peak and whereby a recess projects into the tread block at a location within the tread thickness below the first portion;
where each of the plurality of tread blocks includes a sipe extending into the tread thickness from the outer, ground-engaging side of the tread, where the sipe is generally inclined relative to the direction of the tread thickness, such that as the sipe extends into the tread thickness from the outer, ground-engaging side, the sipe extends towards the trailing side of the corresponding tread block; and,
a groove arranged along the sipe within the tread thickness and spaced below the outer, ground-engaging side of the tread, the groove being asymmetric relative to a centerline of the sipe, the centerline arranged midway across a width of the sipe as the sipe extends into the tread thickness from the outer, ground-engaging side.

2. The tire tread of claim 1, where for each of the plurality of tread blocks, the leading side extends into the tread thickness from the outer, ground-engaging side in the direction of the tread thickness.

3. The tire tread of claim 1, where each of the plurality of lateral grooves has a bottom that includes a planar portion extending substantially across a width of the corresponding lateral groove.

4. The tire tread of claim 3, where for each of the plurality of lateral grooves, a tapering transition is arranged at a junction between the bottom and each of the leading and trailing sides.

5. (canceled)

6. The tire tread of claim 1, where the first inclined portion extends into the tread thickness by an average non-zero angle measured relative to the direction of the tread thickness.

7. The tire tread of claim 1, where the first inclined portion includes a planar portion, the planar portion being inclined by a non-zero angle measured relative to the direction of the tread thickness.

8. The tire tread of claim 6, where the non-zero angle is equal to 6 degrees to 60 degrees.

9. The tire tread of claim 1, where a second portion extends from the peak, the second portion at least partially defining the recess, where the second portion of the trailing side extends further into the tread thickness both in the direction of the tread thickness and toward the leading side of the tread block.

10. The tire tread of claim 9, where the second portion extends into the tread thickness by an average non-zero angle measured relative to the direction of the tread thickness.

11. The tire tread of claim 9, where the second portion includes a planar portion, the planar portion being inclined by a non-zero angle measured relative to the direction of the tread thickness.

12. The tire tread of claim 10, where the non-zero angle is equal to 6 degrees to 60 degrees.

13. The tire tread of claim 9, where the second portion is spaced apart from the bottom for each of the plurality of lateral grooves.

14. The tire tread of claim 13, where the trailing side includes a third portion arranged between the second portion and the bottom for each of the plurality of lateral grooves.

15. The tire tread of claim 1, where the sipe is inclined by an average angle measured relative to the direction of the tread thickness.

16. The tire tread of claim 1, where the sipe is inclined linearly by an angle measured relative to the direction of the tread thickness.

17. The tire tread of claim 16, where the angle is equal to 0 to 45 degrees.

18. (canceled)

19. The tire tread of claim 18, where the angle is equal to one-half of an inclination angle of the first portion of the trailing side.

20. The tire tread of claim 1, where the groove is arranged at an inner terminal end of the sipe.

21. The tire tread of claim 20, where the groove extends from the sipe in a direction towards the leading side.

22. The tire tread of claim 1, where a tapering segment is arranged at a junction between the sipe and the outer, ground-engaging side.
